(19) United States
(12) Patent Application Publication
(10) Pub. No.: US 2004/0003775 A1
(43) Pub. Date: Jan. 8, 2004

(54) Shadow mask for fabricating flat display

(75) Inventor: Chang Nam Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/609,400

(22) Filed: Jul. 1, 2003

(30) Foreign Application Priority Data
Jul. 3, 2002 (KR) P 2002-38347

(51) Int. Cl. B05C 11/00; B05C 21/00

(52) U.S. Cl. 118/504

(57) ABSTRACT

Shadow mask for fabricating a flat display including a first substrate having a plurality of first via holes, and a second substrate on the first substrate, the second substrate having a plurality of second via holes, wherein the first via holes and the second via holes are arranged to overlap with each other, and the second via hole has a diameter greater than a diameter of the first via hole.

This application claims the benefit of the Korean Application No. P2002-38347 filed on Jul. 3, 2002, which is hereby incorporated by reference.

### BACKGROUND OF THE INVENTION

1. Field of the Invention

The present invention relates to a shadow mask for fabricating a flat display.

2. Background of the Related Art

In general, the shadow mask is used in fabricating a full color flat display for forming R, G, B pixels each having good color feeling, and luminous efficiency.

Referring to FIGS. 1A and 1B, the shadow mask used in fabrication of the flat display is provided with a substrate 1, and a plurality of via holes 2 in the substrate 1. The shadow mask may be formed by wet-etching, or electro-forming.

FIGS. 2A and 2B illustrate shadow masks each formed by wet-etching, and FIGS. 3A and 3B illustrate shadow masks each formed by electro-forming.

Referring to FIGS. 2A and 2B, the shadow mask formed by wet-etching has via holes each having a top part size different a bottom part size. That is, the via hole has a sloped sidewall.

However, the shadow mask formed by wet-etching has a great distance between adjacent via holes, which is not suitable for fabrication of a display panel that requires a high precision.

In the meantime, referring to FIGS. 3A and 3B, the shadow mask formed by the electro-forming has via holes each with equal top and bottom part size. That is, the via hole has a vertical sidewall.

However, the shadow mask formed by electro-forming causes to have a shadow phenomenon depending on positions of deposition sources when a material is deposited on a display panel by using the shadow mask.

Referring to FIG. 3B, the shadow phenomenon causes failure in accurate deposition of the material on a desired position of the display panel, which results in non-uniform light emission from the pixel.

### SUMMARY OF THE INVENTION

Accordingly, the present invention is directed to a shadow mask that substantially obviates one or more of the problems due to limitations and disadvantages of the related art.

An object of the present invention is to provide a shadow mask suitable for fabrication of a display that requires a high precision.

Another object of the present invention is to provide a shadow mask having no show phenomenon and a high reliability.

Additional features and advantages of the invention will be set forth in the description which follows, and in part will be apparent to those having ordinary skill in the art upon examination of the following or may be learned from practice of the invention. The objectives and other advantages of the invention will be realized and attained by the structure particularly pointed out in the written description and claims hereof as well as the appended drawings.

To achieve these objects and other advantages and in accordance with the purpose of the present invention, as embodied and broadly described herein, the shadow mask for fabricating a flat display includes a first substrate having a plurality of first via holes, a second substrate on the first substrate, the second substrate having a plurality of second via holes, wherein the first via holes and the second via holes are arranged to overlap with each other, and the second via hole has a diameter greater than a diameter of the first via hole.

The second substrate may have a thickness thicker than a thickness of the first substrate.

A plurality of the first via holes are arranged on every column, and one second via hole is arranged on every column.

The first and second via holes have a form selected from a circle, a polygon, and stripe.

The shadow mask as further includes a bridge formed on the first substrate between adjacent first via holes.

The bridge has a thickness the same with the thickness of the second substrate, and the bridge is formed across the second via hole.

In another aspect of the present invention, there is provided a shadow mask for fabricating a flat display including a first substrate having a plurality of first via holes, a second substrate on the first substrate, the second substrate having a plurality of second via holes, a third substrate on the second substrate, the third substrate having a plurality of third via holes, wherein the first, second, and third via holes are arranged to overlap with one another, the second via hole has a diameter greater than a diameter of the first via hole, and the third via hole has a diameter greater than the diameter of the second via hole.

The second substrate may have a thickness thicker than a thickness of the first or third substrate.

A plurality of the first via holes are arranged on every column, and one second or third via hole is arranged on every column.

It is to be understood that both the foregoing description and the following detailed description of the present invention are exemplary and explanatory and are intended to provide further explanation of the invention claimed.

### BRIEF DESCRITPION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIGS. 1A and 1B illustrate a plan view and a section each showing a related art shadow mask, respectively;

FIGS. 2A and 2B illustrate related art shadow masks each formed by wet-etching, respectively;

FIGS. 3A and 3B illustrate related art shadow masks each formed by electro-forming, respectively;

FIGS. 4A and 4B illustrate a plan view and a section each showing a shadow mask in accordance with a preferred embodiment of the present invention, respectively;

FIG. 5A illustrates a via hole of a shadow mask in accordance with a preferred embodiment of the present invention;

FIG. 5B illustrates a bridge formed between adjacent via holes;

FIGS. 6A and 6B illustrate thicknesses of shadow masks, and widths of via holes; and

FIGS. 7A and 7B illustrate deposition of a material with a shadow mask of the present invention.

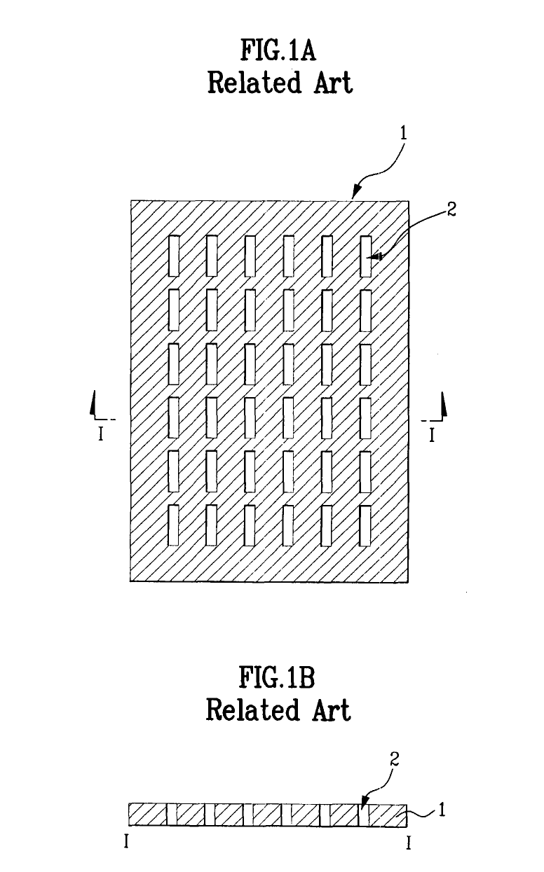

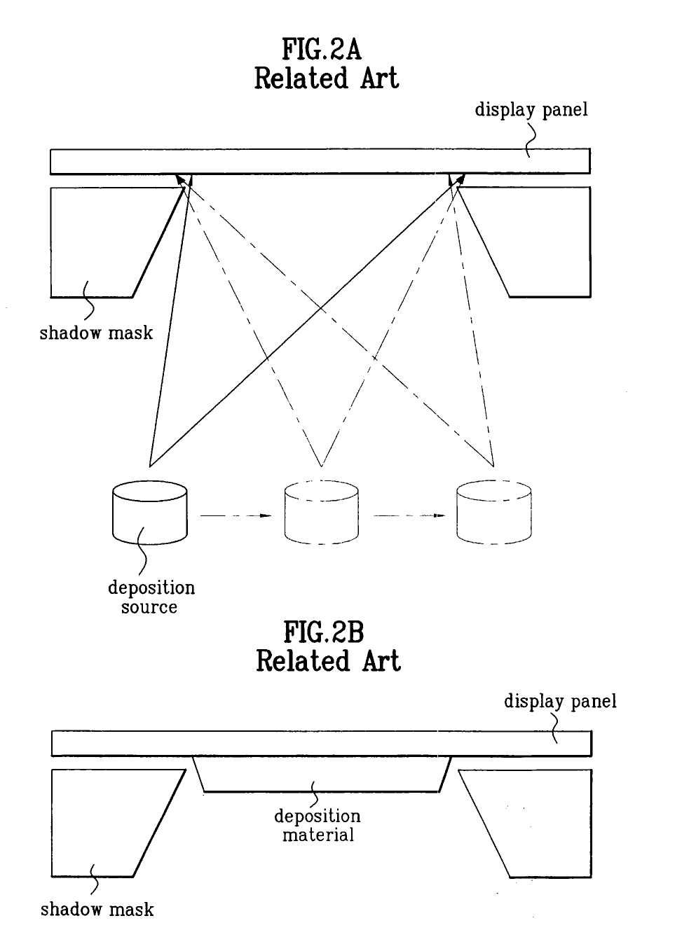

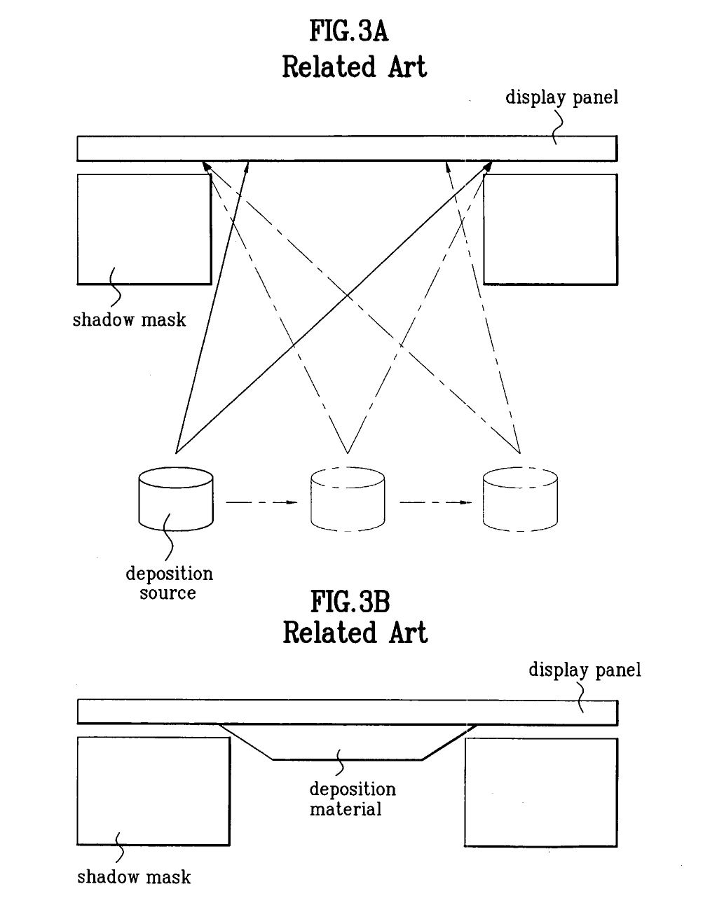

### DETAILED DESCRIPTION OF THE PREFERRED EMBODIMENT

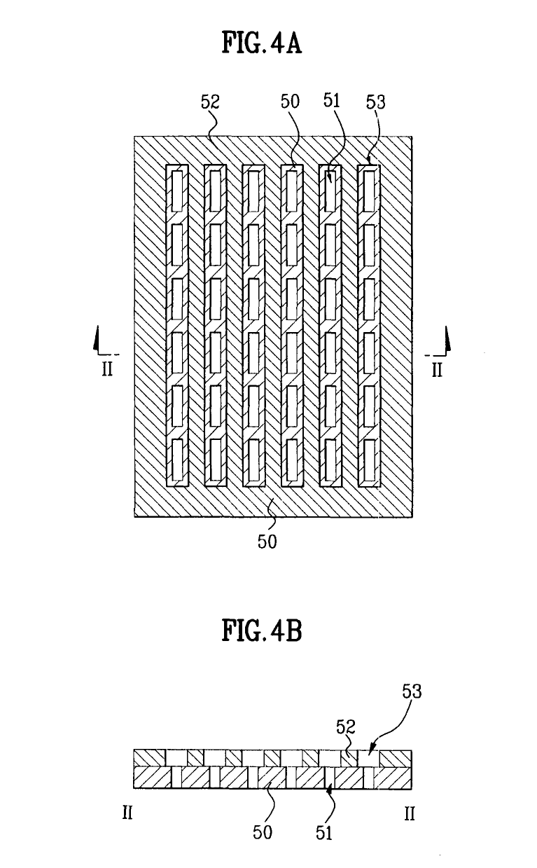

Reference will now be made in detail to the preferred embodiments of the present invention, examples of which are illustrated in the accompanying drawings. FIGS. 4A and 4B illustrate a plan view and a section each showing a shadow mask in accordance with a preferred embodiment of the present invention, respectively.

Referring to FIGS. 4A and 4B, the shadow mask includes a first substrate 50, a plurality of first via holes 51 in the first substrate 50, a second substrate 52 on the first substrate 50, and a plurality of second via holes 53 in the second substrate 52.

The first via holes 51 and the second via holes 53 are arranged, so as to overlap with each other, and a diameter of each of the second via holes 53 is formed to be greater than a diameter of each of the first via holes 51.

The first via hole 51 is rectangular, and a plurality of the first via holes 51 are formed in every column. The second via hole 53 has a form of a stripe formed per every column overlapped with the first via holes 51.

The first, and second via holes 51 and 53 may be formed in a variety of forms, such as circles, polygons, and stripes.

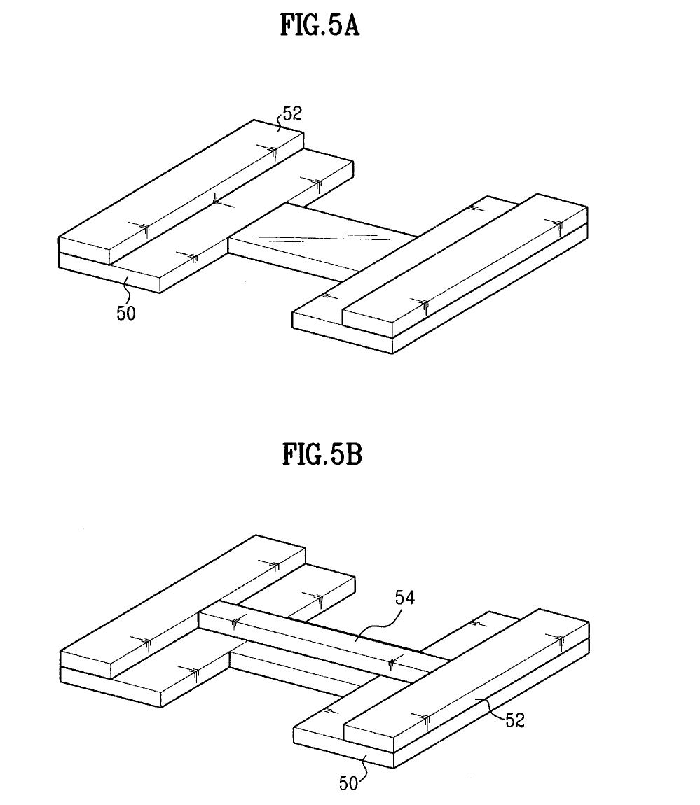

Referring to FIG. 5B, a bridge 54 may be formed on the first substrate 50 between adjacent first via holes 51 additionally, for preventing sagging of the shadow mask. The bridge is formed to have a thickness the same with the second substrate 52 across the second via hole 53.

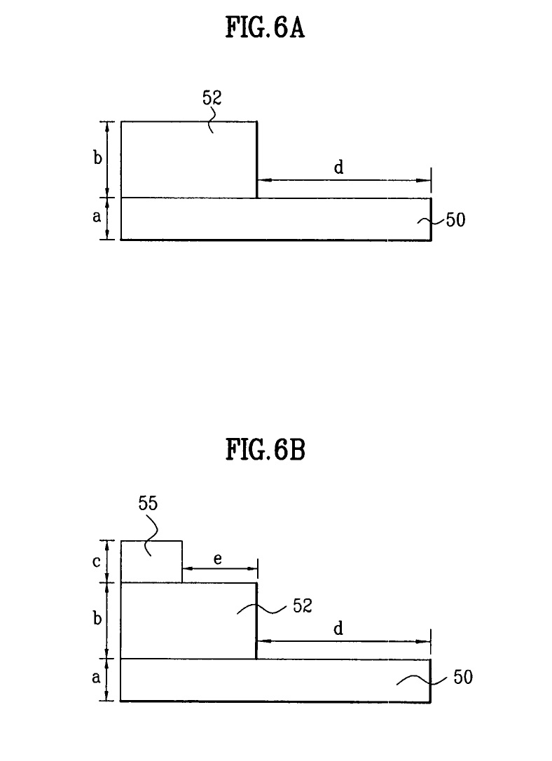

Referring to FIG. 6A, a thickness ‘b’ of the second substrate 52 is thicker than a thickness ‘a’ of the first substrate 50. That is, the first substrate 50 is approx. 1-100 μm thick, and the second substrate 52 is approx. 5-1000 μm thick. The first via hole 51 and the second via hole 53 have approx. a 1-1000 μm diametric difference ‘d’.

As another embodiment shadow mask of the present invention, a third substrate 55 having a plurality of third via holes can be formed on the second substrate 52 additionally.

In this instance, the third via holes are arranged so as to overlap with the second via hole 53, each with a diameter greater than the diameter of the second via hole 53.

Referring to FIG. 6B, the third substrate 55 has a thickness ‘c’ thinner than the thickness ‘b’ of the second substrate 52. That is, the thickness ‘c’ of the third substrate 55 is approx. 1-100 μm. The diametric difference ‘d’ between the first and second via holes, or a diametric difference ‘e’ between the second and third via holes is approx. 1-1000 μm. A plurality of first via holes are arranged on every column, and one second, or third via hole is arranged on every column.

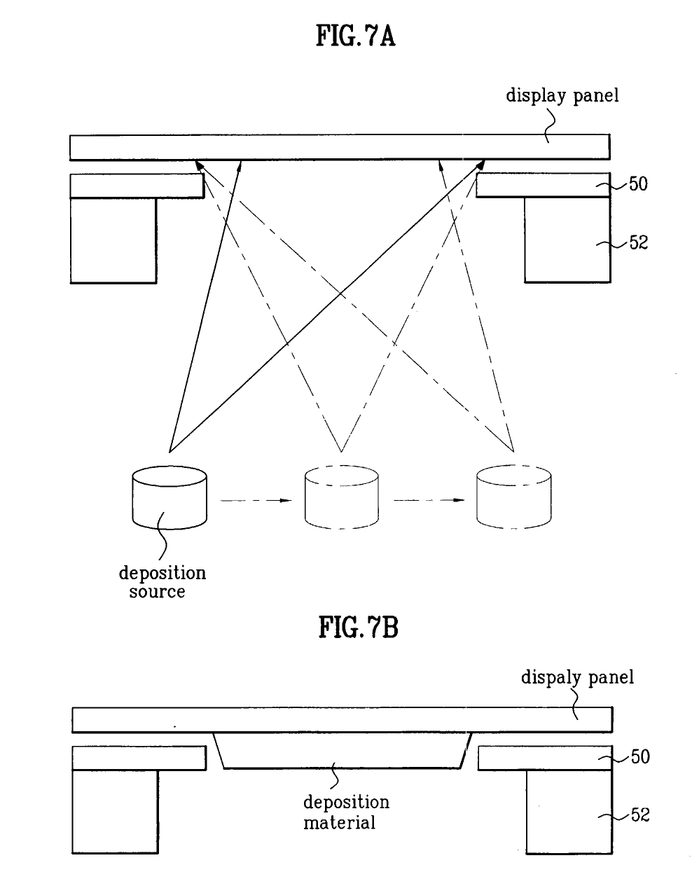

FIGS. 7A and 7B illustrate deposition of a material with a shadow mask of the present invention.

Referring to FIGS. 7A and 7B, when a material is deposited on a display panel with the shadow mask of the present invention, the material can be deposited on an accurate pixel position without the shadow phenomenon.

The shadow mask of the present invention provides a high process reliability as the shadow phenomenon is eliminated, permitting to overcome a drawback of the shadow mask formed by electro-forming. The present invention, employing the electro-forming, is suitable for fabrication of a display that requires a high precision.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A shadow mask for fabricating a flat display, comprising:
a first substrate having a plurality of first via holes;
a second substrate on the first substrate, the second substrate having a plurality of second via holes;
wherein the first via holes and the second via holes are arranged to overlap with each other, and the second via hole has a diameter greater than a diameter of the first via hole.

2. The shadow mask as claimed in claim 1, wherein the second substrate has a thickness thicker than a thickness of the first substrate.

3. The shadow mask as claimed in claim 2, wherein the first substrate is 1-100 μm thick, and the second substrate is 5-1000 μm thick.

4. The shadow mask as claimed in claim 1, wherein the first via hole and the second via hole have a 1-1000 μm diametric difference.

5. The shadow mask as claimed in claim 1, wherein a plurality of the first via holes are arranged on every column, and one second via hole is arranged on every column.

6. The shadow mask as claimed in claim 5, wherein the first and second via holes have a form selected from a circle, a polygon, and stripe.

7. The shadow mask as claimed in claim 1, further comprising a bridge formed on the first substrate between adjacent first via holes.

8. The shadow mask as claimed in claim 7, wherein the bridge has a thickness the same with the thickness of the second substrate.

9. The shadow mask as claimed in claim 7, wherein the bridge is formed across the second via hole.

10. A shadow mask for fabricating a flat display, comprising:
a first substrate having a plurality of first via holes;
a second substrate on the first substrate, the second substrate having a plurality of second via holes;
a third substrate on the second substrate, the third substrate having a plurality of third via holes;
wherein the first, second, and third via holes are arranged to overlap with one another, the second via hole has a diameter greater than a diameter of the first via hole, and the third via hole has a diameter greater than the diameter of the second via hole.

11. The shadow mask as claimed in claim 10, wherein the second substrate has a thickness thicker than a thickness of the first or third substrate.

12. The shadow mask as claimed in claim 11, wherein the first or third substrate is 1-1000 μm thick, and the second substrate is 5-1000 μm thick.

13. The shadow mask as claimed in claim 10, wherein the first via hole and the second via hole, or the second via hole and the third via hole, have a 1-1000 μm diametric difference.

14. The shadow mask as claimed in claim 10, wherein a plurality of the first via holes are arranged on every column, and one second or third via hole is arranged on every column.

15. The shadow mask as claimed in claim 14, wherein the first, second, and third via holes have forms selected from a circle, a polygon, and stripe.

16. The shadow mask as claimed in claim 10, further comprising a bridge formed on the first substrate between adjacent first via holes.

17. The shadow mask as claimed in claim 16, wherein the bridge has a thickness the same with the thickness of the second substrate.

18. The shadow mask as claimed in claim 16, wherein the bridge is formed across the second via hole.
